(19) United States
(12) Patent Application Publication
(10) Pub. No.: US 2014/0143601 A1
(43) Pub. Date: May 22, 2014

(54) DEBUG DEVICE AND DEBUG METHOD

(71) Applicants: INVENTEC (PUDONG) TECHNOLOGY CORPORATION, Shanghai (CN); INVENTEC CORPORATION, Taipei (TW)

(72) Inventor: Chia-Hsiang Chen, Taipei (TW)

(73) Assignees: INVENTEC CORPORATION, Taipei (TW); INVENTEC (PUDONG) TECHNOLOGY CORPORATION, Shanghai (CN)

(21) Appl. No.: 13/803,035

(22) Filed: Mar. 14, 2013

(30) Foreign Application Priority Data
Nov. 16, 2012 (CN) 201210465168.0

(51) Int. Cl. G06F 11/22

(52) U.S. Cl. CPC G06F 11/2284
USPC 714/36

(57) ABSTRACT

A debug device is presented, which is applicable to a server having a control chip. The debug device includes a receiving unit, a retrieving unit, an analyzing unit, and a processing unit. The receiving unit is coupled to the control chip and is used for receiving a boot detection signal (BDS). The retrieving unit is coupled to the receiving unit and is used for receiving the BDS through the receiving unit and retrieving an information code of the BDS. The analyzing unit has a lookup table, is coupled to the retrieving unit, and is used for receiving the information code, using the lookup table to analyze the information code and generating an analysis result. The processing unit is coupled to the analyzing unit and is used for receiving the analysis result and generating a processing signal according to the analysis result.

### CROSS-REFERENCE TO RELATED APPLICATIONS

This non-provisional application claims priority under 35 U.S.C. §119(a) on Patent Application No(s). 201210465168.0 filed in China, P.R.C. on Nov. 16, 2012, the entire contents of which are hereby incorporated by reference.

### BACKGROUND

1. Technical Field

The present disclosure relates to a debug device, and more particularly to a debug device and a debug method applicable to a server.

2. Related Art

In a current server, when the server is started, a basic input/output system (BIOS) is loaded first, allowing for the BIOS to perform the complete checking and testing on the hardware in the server. This checking and testing action is also referred to as a power on self test (POST). After completion of the checking and testing of the hardware in the server, the BIOS delivers information about the hardware in the server to an operating system, so that the operating system continues to complete a boot process. However, if certain hardware components in the server malfunction, the boot process may not continue as it normally would.

Therefore, when any hardware component of the server malfunctions and before the operating system takes over, as long as a code of a specific input/output (10) port, for example, Port 80 and a checking stage corresponding to the code are present, the corresponding malfunctioning hardware component of the server can be detected. Currently, a most frequently applied debug method is to use a debug module disposed on a motherboard to retrieve the code associated with the Port 80 and display the code of the Port 80, so that the identity of the malfunctioning hardware may be revealed.

However, since the space of the motherboard of the server is limited, installation of the debug module may not be among the top priorities at the time the motherboard is prepared. Absent the debug module, so that information of the Port 80 (e.g., the code of the same Port 80) may not be learned, and the corresponding debugging and error analysis cannot be easily performed after the subsequent mass production of the motherboards of the server.

### SUMMARY

The present disclosure aims to provide a debug device and a debug method, which can be used to reduce debugging time, cost and execution difficulty of a server and improve debugging efficiency.

A debug device of the present disclosure is applicable to a server, where the server comprises a control chip. The debug device includes a receiving unit, a retrieving unit, an analyzing unit, and a processing unit. The receiving unit is coupled to the control chip and is used for receiving a boot detection signal (BDS). The retrieving unit is coupled to the receiving unit and is used for receiving the BDS through the receiving unit and retrieving an information code of the BDS. The analyzing unit has a lookup table, is coupled to the retrieving unit, and is used for receiving the information code, analyzing the information code using the lookup table, and generating an analysis result. The processing unit is coupled to the analyzing unit and is used for receiving the analysis result and generating a processing signal according to the analysis result.

In an embodiment, the analyzing unit compares the information code with a preset information code in the lookup table. When the information code matches the preset information code, the analyzing unit generates the analysis result indicative of “matching.” When the information code fails to match the preset information code, the analyzing unit generates the analysis result indicative of “mismatching.”

In an embodiment, the debug device further includes a first storage unit and a second storage unit. The first storage unit is coupled to the retrieving unit and is used for storing the information code. The second storage unit is coupled to the analyzing unit and is used for storing the analysis result.

In an embodiment, the receiving unit comprises a low pin count (LPC) interface.

In an embodiment, the processing signal of the receiving unit includes a reset signal, a power restart signal, or a system status maintenance signal.

A debug method of the present disclosure is applicable to a server, where the server comprises a control chip. The debug method includes the following steps of receiving a BDS prepared by the control chip, retrieving an information code of the BDS, using a lookup table to analyze the information code and generating an analysis result, and generating a processing signal according to the analysis result.

In an embodiment, the step of using the lookup table to analyze the information code and generating the analysis result further includes obtaining a preset information code in the lookup table, determining whether the information code matches the preset information code, if the information code matches the preset information code, generating an analysis result of matching, and if the information code does not match the preset information code, generating an analysis result of mismatching.

In an embodiment, the debug method further includes storing the information code of the BDS and storing the analysis result.

In an embodiment, the processing signal includes a reset signal, a power restart signal, or a system status maintenance signal.

In the debug device and the debug method of the present disclosure, the information code of the BDS prepared by the control chip is retrieved through the retrieving unit, and the analyzing unit analyzes the information code by using the lookup table and generates the analysis result. Then the processing unit generates the processing signal according to the analysis result, so that the server performs a corresponding mechanism responding to the occurrence of an error. Therefore, the debugging time, cost, and execution difficulty of the server may be reduced and the debugging efficiency may be improved.

As for features and examples of the present disclosure, embodiments will be illustrated in detail with reference to the accompanying drawings in the following.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic view of a server according to one embodiment of the present disclosure;

FIG. 2 is a flow chart of a debug method according to one embodiment of the present disclosure; and

FIG. 3 is a flow chart of another debug method according to one embodiment of the present disclosure.

### DETAILED DESCRIPTION

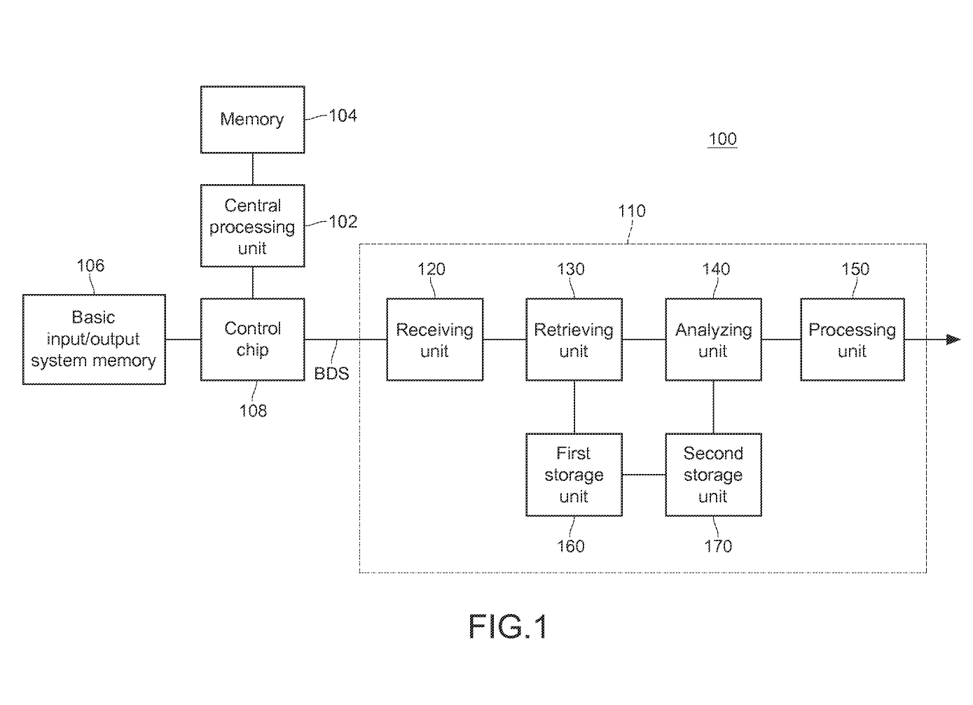

Referring to FIG. 1, a schematic view of a server 100 according to one embodiment of the present disclosure is illustrated. The server 100 includes a central processing unit (CPU) 102, a memory (Dual In-line Memory Module, DIMM) 104, a BIOS memory 106, a control chip 108, and a debug device 110. The CPU 102 is coupled to the memory 104. The BIOS memory 106 is used for storing a BIOS. The control chip 108 is coupled to the CPU 102 and the BIOS memory 106.

In addition, the control chip 108 is coupled to the CPU 102, for example, through a direct media interface (DMI) bus. The control chip 108 is coupled to the BIOS memory 106, for example, through a serial peripheral interface (SPI) bus. The CPU 102, the memory 104, and the BIOS memory 106 are not key points in the present disclosure and are therefore not described herein again in detail.

The debug device 110 may include a receiving unit 120, a retrieving unit 130, an analyzing unit 140, and a processing unit 150.

The receiving unit 120 is coupled to the control chip 108 and is used for receiving a boot detection signal (BDS). In this embodiment, the receiving unit 120 includes for example, a low pin count (LPC) interface, and the debug device 110 is coupled to the control chip 108 through the LPC interface, so as to receive the BDS generated by the control chip 108.

The retrieving unit 130 is coupled to the receiving unit 120 and is used for receiving, through the receiving unit 120, the BDS generated by the control chip 108 and retrieving an information code of the BDS. The control chip 108 is, for example, a south bridge (SB) chip or a platform controller hub (PCH) chip of a main board of the server 100.

The BIOS memory 106 may store a plurality of POST codes in advance to represent different POST stages. When the server 100 is to enter a certain POST stage, a value of a POST code representing this particular stage is sent to a specific IO port such as Port 80.

In addition, the control chip 108 is coupled to the BIOS memory 106 and outputs the BDS associated with the motherboard corresponding to a POST code in the boot process of the server 100. After receiving the BDS, the retrieving unit 130 retrieves an information code of the BDS and outputs the retrieved information code. The information code, for example, corresponds to the POST code.

The analyzing unit 140 is configured with a lookup table and the analyzing unit 140 is coupled to the retrieving unit 130. The analyzing unit 140 receives the information code retrieved by the retrieving unit 130, employs the lookup table configured therein to analyze the information code and generates an analysis result accordingly. In one implementation, the analyzing unit 140 compares this information code with a preset information code stored in the lookup table, so as to determine whether the information code matches the preset information code, and generates the analysis result indicative of either matching or mismatching.

The processing unit 150 is coupled to the analyzing unit 140 and is used for receiving the analysis result and generating a processing signal according to the analysis result. The processing signal may include, for example, a reset signal, a power restart signal, or a system status maintenance signal. For example, when the analysis result suggests that the information code and the preset information code do not match, the processing unit 150 may generate a corresponding processing signal, for example, a reset signal, a power restart signal, or a system status maintenance signal, which may be indicative of the server 100 may malfunction, so as to control the server 100 to perform a corresponding operation.

In another aspect, when the analysis result indicates that the information code matches the preset information code, the processing unit 150 may conclude that no error occurs in the server 100 before generating the corresponding processing signal, for example, a system status maintenance signal, allowing for the server 100 to continue the boot process.

In addition, the debug device 110 further includes a first storage unit 160 and a second storage unit 170. The first storage unit 160 is coupled to the retrieving unit 130 and is used for storing the information code retrieved by the retrieving unit 130. The first storage unit 160 is, for example, a register and the information code may be stored in the register. The second storage unit 170 is coupled to the analyzing unit 140 and is used for storing the analysis result generated by the analyzing unit 140.

First, when a power supply powers the server 100 to boot up, the server 100 performs a power sequence. Subsequently, after the server 100 completes the power sequence the BIOS initiates the POST before generating the corresponding POST code and transmit the POST code to the specific IO port. The control chip 108 may generate the corresponding BDS according to the POST code.

Subsequently, after receiving the BDS through the receiving unit 120, the retrieving unit 130 retrieves the information code of the BDS and provides the information code to the analyzing unit 140. In addition, the retrieving unit 130 also stores the information code in the first storage unit 160, so that whether any error occurs in the server 100 over the course of the boot process may be recognized by having the access to the information code in the first storage unit 160.

Next, the analyzing unit 140 employs the lookup table to compare the information code with the preset information code in the lookup table, so as to generate the corresponding analysis result, which is transmitted to the processing unit 150 and stored in the second storage unit 170. Whether any error occurs in the server 100 over the course of the boot process may be recognized by having the access to the analysis result in the second storage unit 170.

For example, it is assumed that the POST code generated by the BIOS is, for example, “00001101,” the control chip 108 correspondingly provides the BDS of the POST code of “00001101.” Next, the retrieving unit 130 receives the BDS of the POST code of “00001101” through the receiving unit 12, retrieves the information code of the BDS, which is “00001101”, and provides the information code to the analyzing unit 140.

Subsequently, the analyzing unit 140 compares the information code (“00001101”) with the preset information code in the lookup table. If the preset information code is, for example, “00001101,” the analyzing unit 140 may conclude the information code matches the preset information code and correspondingly outputs the analysis result indicative of “matching.” Otherwise, the analyzing unit 140 may correspondingly output the analysis result of “mismatching.”

Next, when the processing unit 150 receives the analysis result indicative of “matching,” the processing unit 150 determines that no error occurs in the server 100 and the processing unit 150 correspondingly generates the processing signal, for example, a system status maintenance signal, so that the server 100 may continues the boot process including the POST. Subsequently, the debug device 110 may continue detecting whether the server 100 malfunctions.

In addition, when the processing unit 150 receives the analysis result indicative of “mismatching,” the processing unit 150 determines that the error occurs in the server 100, and the processing unit 150 correspondingly generates the processing signal, for example, the reset signal, the power restart signal or the system status maintenance signal, so that the server 100 may perform a corresponding process responding to the occurrence of the error.

For example, when the processing signal prepared by the processing unit 150 is a reset signal, the server 100 resets corresponding components according to the reset signal, so that these components could be restored to their respective initial conditions. When the processing signal generated by the processing unit 150 is a power restart signal, the server 100 controls the power supply, according to the power restart signal, to be turned off before turning the power supply back on. Therefore, the server 100 performs the power sequence again and the BIOS enters into the POST stage again, both of which could ensure the debugging to be performed once again.

When the processing signal generated by the processing unit 150 is a system status maintenance signal, the server 100 may continue operating in a current condition according to the system status maintenance signal. That is, if the error refers to the server 100 crashing, the server 100 may remain in the condition of crashing. In this embodiment, the error occurs in the server 100 may include an erroneous access to the memory or the access to the data by an electronic (hardware) component remaining suspended over a predetermined period of time.

In this embodiment, apart from performing the debugging on the control chip 108, the debug device 110 may also, when concluding that an error occurs in the server 100, provide a corresponding mechanism responding to the occurrence of the error including system resetting, power restarting, or system maintenance. Therefore, debugging time, cost, and execution difficulty of the server 100 may be effectively reduced and debugging efficiency may improve.

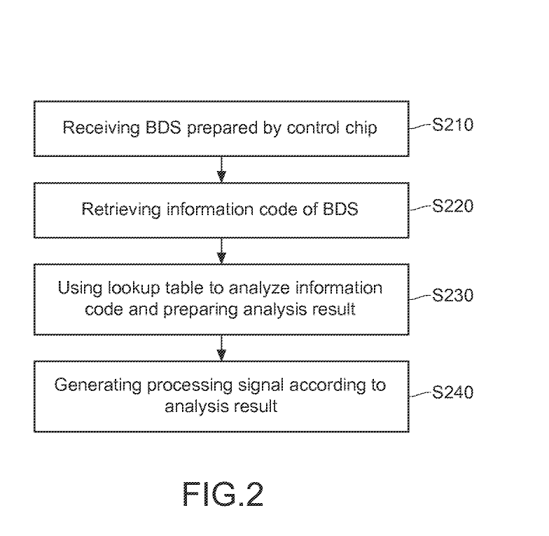

A debug method may be concluded from description of the above embodiment. Referring to FIG. 2, it is a flow chart of a debug method according to one embodiment of the present disclosure. The debug method in this embodiment is applicable to a server including a control chip. In step S210, a BDS prepared by the control chip is received. In Step S220, an information code of the BDS is retrieved. In step S230, a lookup table is used to analyze the information code and an analysis result is generated. In step S240, a processing signal is generated according to the analysis result.

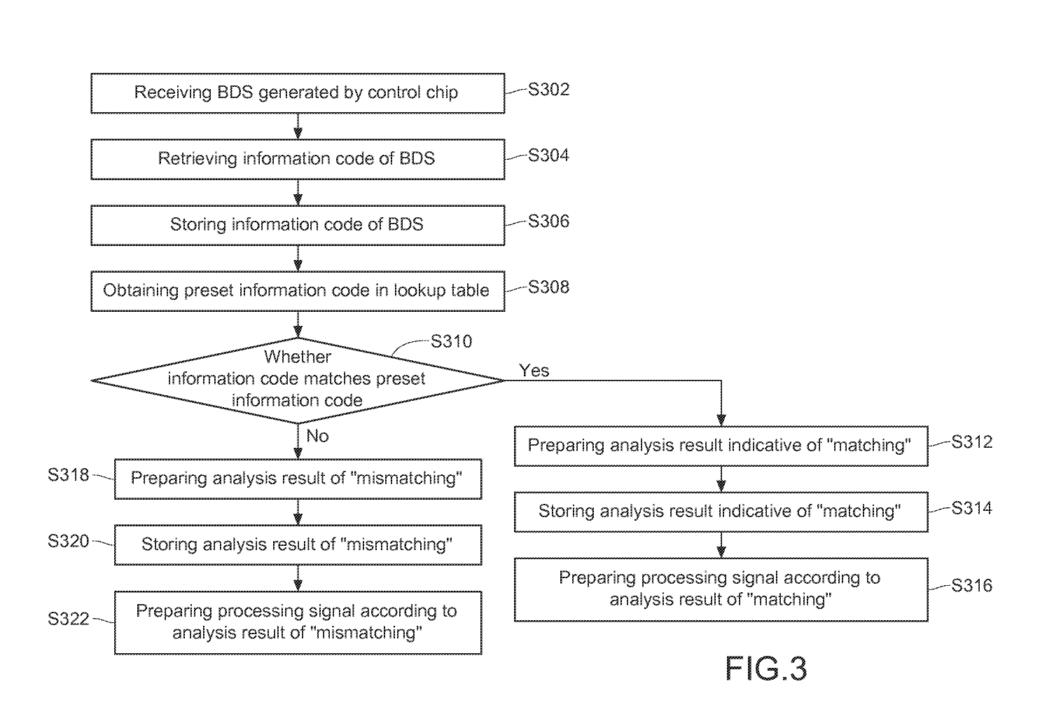

Referring to FIG. 3, it is a flow chart of another debug method according to one embodiment of the present disclosure. The debug method in this embodiment is also applicable to a server having a control chip. In step S302, a BDS generated by the control chip is received. In step S304, an information code of the BDS is retrieved. In step S306, the information code of the BDS is stored. In step S308, a preset information code in a lookup table is obtained.

In step S310, it is determined whether the information code matches the preset information code. If the information code matches the preset information code, the method may proceed to step S312 in which an analysis result of matching is generated. In step S314, the analysis result indicative of “matching” is stored. In step S316, a processing signal is generated according to the analysis result of “matching.”

Following step S310, if the information code fails to match the preset information code, the method may proceed to step S318 in which an analysis result of “mismatching” is generated. In step S320, the analysis result of “mismatching” is stored. In step S322, another processing signal is generated according to the analysis result of “mismatching.”

In the debug device and the debug method of the embodiments of the present disclosure, the information code of the BDS generated by the control chip is retrieved through the retrieving unit, and the analyzing unit analyzes the information code by using the lookup table and produces the analysis result. Then the processing unit generates the processing signal according to the analysis result, so that the server performs a mechanism responding to the occurrence of the error including the system resetting, power restarting, or system maintenance. In addition, the information code and the analysis result are further stored. Therefore, the debugging time, cost, and execution difficulty of the server may be reduced and debugging efficiency may be improved.

What is claimed is:

1. A debug device, applicable to a server, the server comprising a control chip, the debug device comprising:
a receiving unit, coupled to the control chip and used for receiving a boot detection signal;
a retrieving unit, coupled to the receiving unit and used for receiving the boot detection signal through the receiving unit and retrieving an information code of the boot detection signal;
an analyzing unit, storing a lookup table, coupled to the retrieving unit, and used for receiving the information code, and analyzing the information code by using the lookup table to generate an analysis result; and
a processing unit, coupled to the analyzing unit and used for receiving the analysis result and generating a processing signal according to the analysis result.

2. The debug device according to claim 1, wherein the analyzing unit compares the information code with a preset information code of the lookup table, when the information code matches the preset information code, the analyzing unit generates the analysis result indicative of matching, and when the information code fails to match the preset information code, the analyzing unit generates the analysis result indicative of mismatching.

3. The debug device according to claim 1, further comprising:
a first storage unit, coupled to the retrieving unit and used for storing the information code; and
a second storage unit, coupled to the analyzing unit and used for storing the analysis result.

4. The debug device according to claim 1, wherein the receiving unit comprises a low pin count interface.

5. The debug device according to claim 1, wherein the processing signal comprises a reset signal, a power restart signal, or a system status maintenance signal.

6. A debug method, applicable to a server, the server comprising a control chip, the debug method comprising:
receiving a boot detection signal prepared by the control chip;
retrieving an information code of the boot detection signal;
using a lookup table to analyze the information code and generating an analysis result; and
generating a processing signal according to the analysis result.

7. The debug method according to claim 6, wherein the step of using the lookup table to analyze the information code and generating the analysis result comprises:
obtaining a preset information code of the lookup table;
determining whether the information code matches the preset information code;
if the information code matches the preset information code, generating the analysis result indicative of matching; and
if the information code fails to match the preset information code, generating the analysis result of indicative of mismatching.

8. The debug method according to claim 6, further comprising:
storing the information code of the boot detection signal; and
storing the analysis result.

9. The debug method according to claim 6, wherein the processing signal comprises a reset signal, a power restart signal, or a system status maintenance signal.
